(19) United States
(12) Patent Application Publication
(10) Pub. No.: US 2001/0046362 A1
(43) Pub. Date: Nov. 29, 2001

(54) METHOD AND HOLDER FOR AUTOMATED TESTING OF OPTOELECTRONIC DEVICES

(76) Inventors: BRIAN DALE POTTEIGER, READING, PA (US); RORY KEENE SCHLENKER, LENHARTSVILLE, PA (US)

Correspondence Address: RATNER & PRESTIA, SUITE 301 ONE WESTLAKES BERWYN, P O BOX 980, VALLEY FORGE, PA, 194820980

(21) Appl. No.: 09/401,434

(22) Filed: Sep. 22, 1999

(51) Int. Cl. G02B 6/00

(52) U.S. Cl. 385/139

(57) ABSTRACT

This invention provides a holder for releasably engaging a plug component of an optoelectronic device to facilitate automated testing of the optoelectronic device. The plug component of the optoelectronic device has a body and a flange extending radially outwardly from that body. The holder defines a recess configured to releasably engage the body of the plug to resist movement of the plug with respect to the holder in a direction transverse to the axis of the plug's body. The holder also includes a surface oriented for contact with the flange of the plug to resist movement of the plug with respect to the holder in a direction along the axis of the plug's body. A corresponding method is also provided.

### FIELD OF THE INVENTION

This invention relates to a method and holder for automated testing of optoelectronic devices. More particularly, this invention relates to a method and holder for releasably engaging a plug component of an optoelectronic device.

### BACKGROUND OF THE INVENTION

Optoelectronic devices, such as those that provide a light source and a fiber-optic cable extending therefrom, should be tested before they are placed in service in order to confirm that the light source of the optoelectronic device performs as intended. Such devices should also be tested to confirm that the fiber-optic cable component adequately transmits the light generated by the light source of the optoelectronic device.

In order to conduct such performance tests, it is beneficial to position the terminal end of the fiber-optic cable component of the optoelectronic device adjacent to test equipment. More specifically, it is beneficial to position the end of the fiber-optic cable adjacent a light receiver that can measure the properties of the light that is generated and transmitted by the optoelectronic device.

A connector can be mounted on the fiber-optic cable to form an optoelectronic assembly and the connector can then be connected to test equipment. For example, a connector mounted at the terminal end of the fiber-optic cable can be coupled to a light receiver. After the test is completed, the connector of the optoelectronic device can be removed from the test equipment and the optoelectronic assembly can be placed in service if the results of the test are favorable.

A variety of fiber-optic cable connector components may be available for use with a particular optoelectronic device. This is because the configuration of the connector component selected for use with a particular optoelectronic device depends on the ultimate application of the device as well as the specifications and preferences of the purchasers or end users of the device.

It has been recognized, however, that tests conducted by connecting the connector of an optoelectronic assembly to test equipment cannot be easily automated because of the variations that exist between alternative connector designs. Therefore, such tests tend to be labor intensive. Furthermore, the making and breaking of connections between the connector and the test equipment can result in catastrophic damage to the optoelectronic assembly because the fiber-optic cable components of such devices may be susceptible to such damage if mishandled. Also, mishandling of such devices can, in some circumstances, cause latent damage to the fiber-optic cable component—damage that may not be discoverable until some time after the optoelectronic assembly has been placed in service.

Accordingly, it is an object of this invention to provide a method and holder for testing of optoelectronic devices in such a way as to overcome the disadvantages associated with the prior art.

### SUMMARY OF THE INVENTION

This invention provides a holder for releasably engaging a plug component of an optoelectronic device to facilitate automated testing of the optoelectronic device. The plug component of the optoelectronic device preferably has an elongated body and a flange extending radially outwardly from the body. The holder defines a recess configured to releasably engage the body of the plug component to resist movement of the plug component with respect to the holder, once the plug component is installed in the holder, in a direction transverse to the axis of the plug component's body. The holder also defines a surface configured to contact the flange of the plug component to resist movement of the plug component with respect to the holder, once the plug component is installed in the holder, in a direction along the axis of the plug component's body.

Also provided by this invention is a method for testing an optoelectronic device. The method includes the step of providing a holder defining a recess configured to releasably engage a body of the plug component and defining a surface configured to contact a flange extending from the body of the plug component. The method further includes releasably engaging the plug component in the holder. The method uses the recess defined by the holder to resist movement of the plug component with respect to the holder in a direction transverse to the axis of the plug component. The method also uses the surface defined by the holder to resist movement of the plug component with respect to the holder in a direction along the axis of the plug component's body.

### BRIEF DESCRIPTION OF THE DRAWINGS

The invention will be described with reference to specific embodiments selected for illustration in the drawings, of which:

FIG. 1 is a perspective top view of an embodiment of a testing fixture with which a holder and method according to this invention can be used.

FIG. 2 is a perspective top view of embodiments of a plug component and a holder according to aspects of this invention.

FIG. 3 is a perspective top view of the holder illustrated in FIG. 2, with the plug component illustrated in FIG. 2 installed therein.

FIG. 4 is a perspective bottom view of the holder and plug component illustrated in FIG. 3.

FIG. 5 is a perspective top view illustrating details of the plug component and holder illustrated in FIG. 2.

### DETAILED DESCRIPTION OF THE INVENTION

Exemplary features of this invention will now be described with reference to specific embodiments selected for illustration in the drawings. It will be appreciated that this description does not limit the spirit or scope of the invention, which is defined separately in the appended claims. It should also be appreciated that the drawings are not rendered to any particular proportion or scale.

Generally, the holder and method according to this invention are adapted for automated testing of optoelectronic devices by means of automatic optical connection. It has been contemplated that a single fixture could be designed to accommodate the multiple connector configurations that may be used with particular optoelectronic devices, and that such a fixture might help to automate the testing procedure. In other words, a fixture could be designed to hold connectors having a variety of shapes and sizes after such connectors are mounted on an optoelectronic device to form an optoelectronic assembly. It is recognized, however, that the design and construction of such a “universal” fixture can be complicated and expensive.

Rather than testing optoelectronic devices to which a particular connector has already been attached to form an optoelectronic assembly (e.g., a connector selected for use with the device in service, which may be of a size and configuration that differs from other connectors that can be used with the same optoelectronic device), and rather than providing a fixture particularly adapted to accommodate various connectors, the holder and method according to this invention is instead adapted for use with a standardized plug component that can be connected to the fiber-optic cable of the optoelectronic device for use as a test plug for testing purposes. In this manner, the performance of the optoelectronic device, as well as the performance of the fiber-optic cable itself, can be confirmed in such a way as to reduce or minimize the manual handling of the devices.

Subsequent to testing, the standardized plug component can be replaced with a particular connector or modified before it is delivered to the end user. In other words, the optoelectronic device can be “re-connectorized” after the test is conducted in order to customize the optoelectronic device for a particular customer or user. Alternatively, the optoelectronic device can be provided to the end user with the standardized plug component mounted thereon. The plug component is preferably itself an internal component of connector systems.

It has been discovered that the use of a standardized plug component as a test plug makes it possible to utilize a single holder during the testing procedure. It will be appreciated that the use of a standardized test plug component therefore makes it possible to automate the testing procedure, minimize the expense of labor, and reduce the potential for catastrophic or latent fiber-optic damage.

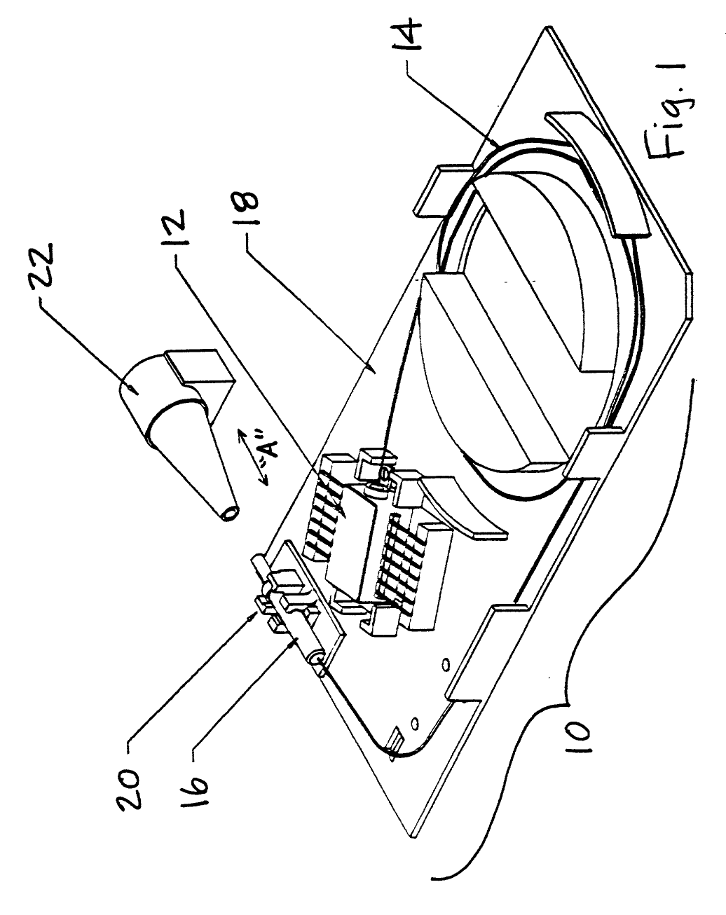

Referring generally to FIGS. 1-5, an exemplary embodiment of a holder 20 according to this invention is provided for releasably engaging a plug component 16 of an optoelectronic device 12 to facilitate automated testing of the optoelectronic device 12. The plug component 16 has an elongated body 24 and a flange 28 extending outwardly from the body 24.

The holder 20 includes a recess 54 configured to releasably engage the body 24 of the plug component 16 to resist movement of the plug component 16 with respect to the holder 20, once the plug component 16 is installed in the holder 20, in a direction “B” transverse to the axis 26 of the plug component 16. The holder 20 also includes a surface, defined by flange portion 48 for example, oriented for contact with the flange 28 of the plug component 16 to resist movement of the plug component 16 with respect to the holder 20, once the plug component 16 is installed in the holder 20, in a direction “A” along the axis 26 of the plug component 16.

In use for testing an optoelectronic device such as device 12 according to exemplary aspects of this invention, a plug component 16 is provided on a fiber-optic cable component 14 of the optoelectronic device 12. A holder 20 is provided defining the recess 54, which is configured to releasably engage the body 24 of the test plug component 16, and the surface (e.g., of portion 48) which is oriented for contact with the flange 28 of the test plug component 16.

The test plug component 16 is releasably engaged in the holder 20. Movement of the test plug component 16 is resisted with respect to the holder 20 in a direction “B” transverse to the axis 26 of the test plug component 16 using the recess 54 defined by the holder 20. Also, movement of the test plug component 16 is resisted with respect to the holder 20 in a direction “A” along the axis 26 of the test plug component 16 using the surface (e.g., of portion 48) defined by the holder 20.

Referring specifically to FIG. 1, a testing fixture 10, with which a holder and method according to this invention can be used, is illustrated with an optoelectronic device installed therein for testing. Test fixture 10 is configured for testing of the optoelectronic device 12, which provides a source of light. Although test fixture 10 is adapted for use with a variety of optoelectronic devices, one example of such a device is the “L2000” device provided by Lucent Technologies Incorporated, which includes a laser chip to provide a light source.

A fiber-optic cable 14 is connected to optoelectronic device 12 in order to transmit light from optoelectronic device 12 to a receiver (not shown). More specifically, the fiber-optic cable 14 can be used to transmit a laser beam generated by the laser chip of the optoelectronic device 12. Connected at a terminal end of fiber-optic cable 14 is a plug component such as the fiber-optic test plug 16, which is shown in FIG. 1 as being mounted in test plug holder 20.

An automated test head 22 is also illustrated in FIG. 1. Test head 22 is moveable SO that it can be positioned adjacent to the end of fiber-optic test plug 16 and subsequently positioned away from fiber-optic test plug 16. In the exemplary embodiment illustrated in FIG. 1, automated test head 22 includes an opening, oriented to be substantially co-axial with test plug 16, that is sized to receive an end portion of test plug 16 when the test head 22 and test plug 16 are brought together. Although not visible in the figures, the terminal end of fiber-optic cable 14 is flush with the far end of plug 16 to allow for direct contact between a light receiver in test head 22 and the terminal end of the fiber-optic cable 14. Test head 22 is preferably mounted for reciprocal movement toward and away from stationary test plug 16 along the direction “A” as indicated in FIG. 1.

It will be recognized, therefore, that test plug holder 20 is adapted to hold fiber-optic test plug 16 rigidly and repeatedly in a predetermined position in order to facilitate testing using automated test head 22. More specifically, it will be appreciated that alignment of the axis of automated test head 22 with that of fiber-optic test plug 16 is preferred in order to avoid interference as the test head 22 is moved over the end portion of test plug 16, which extends into the opening in test head 22. It will also be appreciated that forces applied to test plug 16 by automated test head 22 in the axial direction “A” should be resisted by test plug holder 20 so that test plug 16 will not move axially as the test head 22 is applied. It will further be appreciated that it is beneficial for test plug 16 to be installable downwardly into test plug holder 20 for releasable engagement therein during the test process and that, at the same time, test plug 16 should be supported so as to prevent axial or rocking movement with respect to holder 20. Furthermore, it is advantageous for test plug holder 20 to be adapted for repeated use so that the testing procedure can be conducted for many iterations and for many optoelectronic devices.

As is illustrated in FIG. 1, test plug holder 20 is mounted on a support structure or “boat” 18. Although the structure or even the existence of boat 18 is not critical to this invention, the testing fixture 10 includes a boat 18 having various upwardly-extending structures to facilitate orientation of optoelectronic device 12 so as to reduce the movement of the optoelectronic device 12. Boat 18 also has upwardly-extending structures that are positioned to permit coiling of fiber-optic cable 14, thereby minimizing the risk of fiber-optic damage.

Although it is contemplated that a plug component, such as test plug 16, can be selected from a variety of such components, it is preferred for test plug 16 to be an internal component of a connector assembly. As for example, a suitable plug component is available from Molex Fiber Optics Incorporated of Woburn, Mass. (Part Number 86010-5010). Holder 20 and boat 18 can be formed from a variety of materials using a variety of methods. For example, an exemplary embodiment of boat 18 or holder 20 can be injection molded from carbon-filled polypropylene. The material used to form boat 18 and holder 20 is preferably conductive. Boat 18 and holder 20 can be formed from the same or different materials, depending upon cost considerations and design preferences.

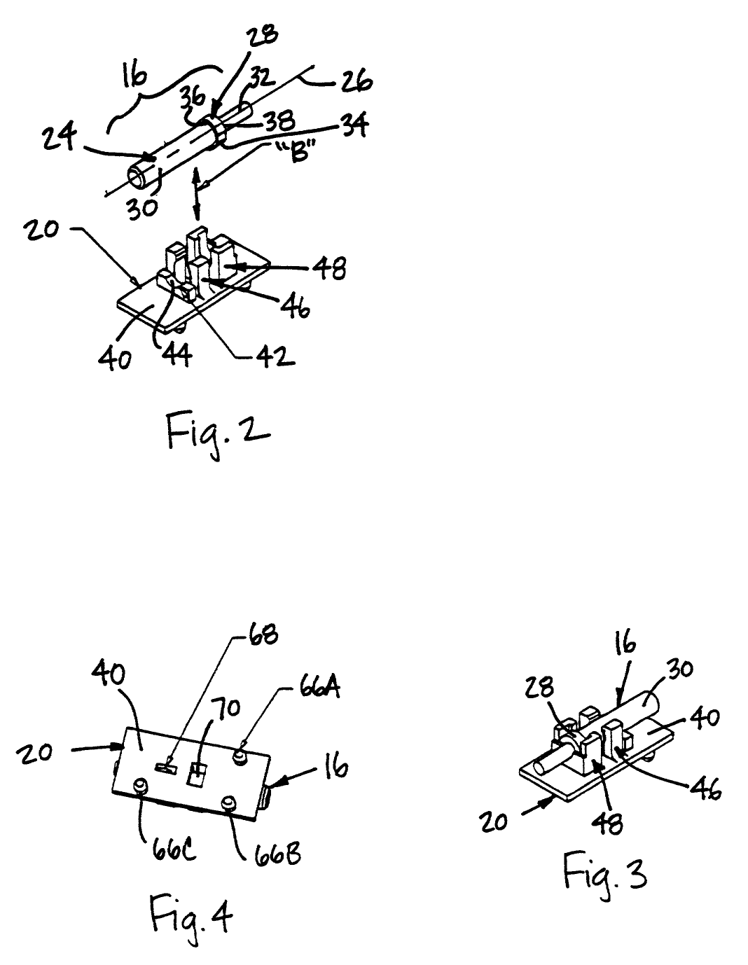

Referring now to FIGS. 2 and 3, preferred features of fiber-optic test plug 16 and test plug holder 20 will now be described. Test plug 16 has an elongated, substantially cylindrical body 24 that extends longitudinally along a longitudinal axis 26. Extending radially outwardly from elongated body 24 is a circumferential flange 28. Flange 28 divides elongated body 24 between a cylindrical body portion 30 and a cylindrical body portion 32. In the exemplary embodiment of test plug 16 illustrated in FIG. 2, cylindrical body portion 32 has a diameter smaller than that of body portion 30. As mentioned with reference to FIG. 1, the end of body portion 32 is sized and shaped to fit within an opening in automated test head 22.

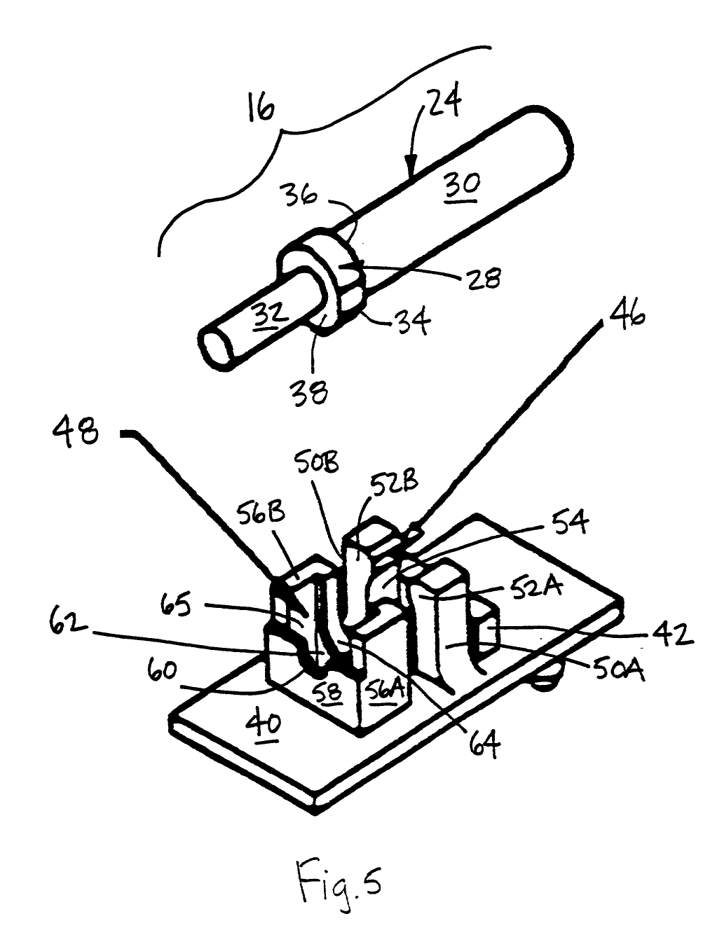

Flange 28 is preferably provided with a beveled portion or tab 34, the purpose of which will be described later with reference to FIG. 4. Also, flange 28 defines an end surface 36 adjacent to body portion 30 as well as an end surface 38 adjacent to body portion 32. End surfaces 36 and 38 are substantially perpendicular to axis 26 of body 24. Although flange 28 in FIG. 2 is spaced from the ends of elongated body 24, it is contemplated that flange 28 may be positioned at or near an end of body 24. Also, flange 28 need not extend circumferentially about the perimeter of body 24, although it preferably does as shown in FIG. 2.

Referring now to the test plug holder 20 shown in FIGS. 2 and 3, plug holder 20 includes a base 40 that provides a substantially flat surface that is substantially parallel to the intended longitudinal axis 26 of test plug 16 when test plug 16 is installed in plug holder 20 (as shown in FIG. 3). Extending upwardly from base 40 of holder 20 is a detent 42 having a recessed surface 44. As shown in FIG. 3, recessed surface 44 of detent 42 accommodates body portion 30 of test plug 16 and acts to cradle body portion 30 in such a way as to resist side-to-side movement of test plug 16 when the test plug 16 is installed in the plug holder 20. Recessed surface 44 of detent 42 also helps to prevent rocking motion of test plug 16 with respect to plug holder 20 upon installation such as, for example, when automated test head 22 contacts test plug 16. Accordingly, detent 42 and recessed surface 44 act in cooperation with an end wall 58 and a recessed surface 60 of a flange portion 48, as will be described in greater detail with reference to FIG. 5.

Also extending upwardly from base 40 of holder 20 is a flange portion 46, which is adapted for releasable engagement of body portion 30 of test plug 16. More specifically, flange portion 46 provides a snap-in engagement of test plug 16 to resist unintended release of test plug 16 from plug holder 20 upwardly in the direction indicated as “B” in FIG. 2. Further details of flange portion 46 will be described later with reference to FIG. 5.

Also extending upwardly from base 40 of plug holder 20 is a flange portion 48 adapted to provide support to test plug 16, when installed, so as to resist longitudinal movement of test plug 16 along longitudinal axis 26 as was described with reference to FIG. 1. More specifically, flange portion 48 defines a cavity shaped and sized to receive flange 28 of test plug 16. End walls (as will be described later with reference to FIG. 5) capture end surfaces 36 and 38 of test plug 16 so as to prevent longitudinal movement as automated test head 22 is brought into contact with test plug 16 (along direction “A” as shown in FIG. 1).

Referring now to FIG. 5 for exemplary details of test plug holder 20, flange portion 46 includes a pair of opposed flange members 50A and 50B, each of which extends upwardly from base 40. At the upward portions of flange members 50A and 50B are provided end portions 52A and 52B, respectively, that extend inwardly toward on another. In this manner, the inwardly facing surfaces of flange members 50A and 50B and end portions 52A and 52B define the recess 54, which is sized and shaped to accommodate body portion 30 of test plug 16.

Flange members 50A and 50B are configured so that they can flex outwardly so that end portions 52A and 52B can move away from one another in order to receive body portion 30 of test plug 16 for a snap-fit, yet releasably engage test plug 16 during testing of the optoelectronic device 12. Similarly, flange members 50A and 50B can also be flexed outwardly away from one another in order to release body portion 30 of test plug 16 from plug holder 20 when such intentional release is desired (e.g., after a test cycle has been completed). In this manner, it is flange portion 46 that resists movement of test plug 16 with respect to holder 20 in a direction “B” that is substantially perpendicular to the axis 26 of plug 16.

Flange portion 48 of holder 20 includes a pair of opposed side walls 56A and 56B. Flange portion 48 also includes an end wall 58 having a recessed surface 60 which is sized and oriented to support body portion 32 of test plug 16. As was introduced with reference to FIGS. 2 and 3, when the test plug 16 is installed in holder 20, recessed surface 60 provides a support for test plug 16, reduces the tendency for test plug 16 to rock with respect to plug holder 20 (in cooperation with recessed surface 44 of detent 42), and resists side-to-side movement of test plug 16. Also included as a part of flange portion 48 is an end wall 62 having a recessed surface 64. Recessed surface 64 is configured so that body portion 30 of test plug 16 can extend therethrough.

End walls 58 and 62 of flange portion 48, together with sidewalls 56A and 56B, at least partially define an open cavity 65 which is sized and shaped to receive and accommodate flange 28 of test plug 16. More specifically, the distance between interior surfaces of sidewalls 56A and 56B is selected so as to provide a close fit with the outer, peripheral surface of flange 28 of test plug 16. In other words, the distance between the interior surfaces of side walls 56A and 56B is equal to or slightly greater than the diameter of flange 28. Accordingly, side walls 56A and 56B act to resist or reduce side-to-side movement of test plug 16 when it is installed within holder 20.

It will also be appreciated from FIGS. 3 and 5 that the distance between end walls 58 and 62 of flange portion 48 is selected to be a close fit with the width of flange 28. In other words, the distance between interior surfaces of end walls 58 and 62 is the same as or slightly greater than the width of flange 28 along the direction of axis 26. Accordingly, this aspect of flange portion 48 prevents or reduces longitudinal movement of test plug 16 along longitudinal axis 26 after test plug 16 is installed within holder 20.

Although cavity 65 is defined by four walls 56A, 56B, 58, and 62 in a preferred embodiment, the cavity can be formed by fewer walls. In fact, any surface oriented to contact the flange 28 of the test plug 16 to resist movement of the test plug 16 along the axis of the plug can be substituted for cavity 65.

Referring now to FIG. 4, which provides a perspective view of the underside of base 40 of test plug holder 20, further details of holder 20 will now be described. Extending downwardly from the bottom surface of holder 20 (upwardly in the view of FIG. 4) is a series of posts 66A, 66B, and 66C, which cooperate to facilitate connection of holder 20 to boat 18 (FIG. 1) by snap-fit engagement in correspondingly positioned holes, or by plastics welds, adhesive bonds, fasteners, or other known attachment means.

Also illustrated in FIG. 4 is an opening 68 defined in the base 40 of holder 20. Opening 68 is not visible in FIGS. 2 and 5 because the position of opening 68 corresponds to the interior of cavity 65. The purpose of opening 68 is to accommodate the beveled portion or tab 34 extending radially outwardly from flange 28 of test plug 16 (see FIG. 2). In this manner, opening 68 of holder 20 engages tab 34, which extends into opening 68, and thereby resists rotational movement of test plug 16 with respect to holder 20 about the axis 26 of test plug 16. The tab 34 also provides a means for radial alignment or orientation of the fiber-optic cable 14 with the test plug 16 during assembly of cable 14 and plug 16. The tab 34, in cooperation with opening 68 of holder 20, also provides for appropriate rotational alignment of test plug 16 vis-a-vis automated test head 22.

An opening 70 is also provided in base 40 of holder 20. Opening 70 is not visible in FIGS. 2 and 5 because the position of opening 70 corresponds to the portion of base 40 that lies between flange members 50A and 50B of flange portion 46. The purpose of opening 70 is to provide access for a portion of the mold tooling used to form holder 20 when holder 20 is made by an injection molding process. More specifically, holder 20 can be formed using a single-cavity injection molding procedure. In order to do so, however, one half of the mold extends through opening 70 so as to form the facing surfaces of flange members 50A and 50B, including the lower portions of end portions 52A and 52B.

Accordingly, it will be appreciated from FIGS. 1-5 that test plug holder 20 is well adapted to releasably engage test plug 16 in a manner that rigidly resists movement of test plug 16 during the testing procedure. More specifically, test plug holder 20 (1) resists upward release of test plug 16 from test plug holder 20 in direction “B” (by action of flange members 50A and 50B of flange portion 46); (2) resists longitudinal movement of test plug 16 along longitudinal axis 26 (by action of end walls 58 and 62 of flange portion 48); (3) resists side-to-side movement of test plug 16 with respect to holder 20 (by side walls 56A and 56B, recessed surface 60 of end wall 58, and recessed surface 64 of end wall 62 of flange portion 48); (4) resists rocking movement of test plug 16 with respect to plug holder 20 (by means of recessed surface 60 of end wall 58 and recessed surface 44 of detent 42); and (5) resists rotational movement of test plug 16 with respect to plug holder 20 (by means of engagement between tab 34 of flange 28 and opening 68 defined in plug holder 20).

Although this invention has been described with reference to specific embodiments selected for illustration in the drawings, it will be appreciated that modifications and variations can be made to the illustrated embodiments without departing from the spirit or scope of this invention. According to the preferred embodiment, this invention makes it possible to provide for top-down loading of a test plug, resistance to movement of the test plug during optical socketing, and orientation of the test plug with respect to other test apparatus.

The test plug holder is preferably an injection-molded component formed from a polymeric material. It is contemplated, however, that this component can be formed from a wide variety of metallic or polymeric materials using a wide variety of manufacturing methods.

It will also be appreciated that, although separate flange portions 46 and 48 have been illustrated to define the recess for snap-fit engagement of the test plug and the surface (e.g. cavity 65) to resist longitudinal movement of the test plug, these features can be combined into a single flange portion. For example, the end portions of flanges 50A and 50B can be provided on the upper portions of recessed surface 64 on the end wall 62 of flange portion 48, and flange portion 46 can then be eliminated.

Furthermore, flange portions 46 and 48 are illustrated as extending upwardly from a base 40 of holder 20. It will be appreciated, however, that an appropriately shaped cavity can be formed, corresponding to the shape of test plug 16, in a block of material to provide a holder while still providing the beneficial functions of this invention. Also, although the invention has been described in connection with the automated testing of optoelectronic devices, it should be recognized that this invention is also useful for other procedures in which plug components are beneficially fixtured, including procedures for aligning, polishing, inspecting, and other manufacturing and testing procedures.

Other variations and modifications and applications of the invention are contemplated. The scope of the invention will now be defined by the appended claims.

What is claimed:

1. A holder for releasably engaging a plug component of an optoelectronic device to facilitate automated testing of the optoelectronic device, the plug having a body and a flange extending radially outwardly therefrom, said holder comprising:
a portion defining a recess configured to releasably engage the body of the plug to resist movement of the plug with respect to said holder in a direction transverse to the axis of the plug; and
a portion defining a surface oriented for contact with the flange of the plug to resist movement of the plug with respect to said holder in a direction along the axis of the plug.

2. A holder as recited in claim 1 wherein the optoelectronic device includes a fiber-optic cable extending through the plug such that a terminal end of the fiber-optic cable is flush with an end of the plug, said holder being configured to facilitate positioning of a test apparatus adjacent the terminal end of the fiber-optic cable.

3. A holder as recited in claim 1 wherein the plug of the optoelectronic device is a component of a connector.

4. A holder as recited in claim 1 wherein the body of the plug is substantially cylindrical, said recess of said holder being sized to accommodate the body of the plug with the body of the plug extending through said recess.

5. A holder as recited in claim 1 wherein the flange of the plug is circumferential, said surface of said holder being oriented to contact an end surface of the flange to resist said movement of the plug in said direction along the axis of the plug.

6. A holder as recited in claim 1 wherein the flange of the plug includes a tab and a portion of said holder defines a recess oriented to accommodate the tab, thereby resisting rotational movement of the plug with respect to said holder about the axis of the plug.

7. A holder as recited in claim 1 wherein the flange of the plug defines end surfaces oriented substantially perpendicular to the axis of the body of the plug, said holder defining a surface oriented for contact with each of the end surfaces of the flange.

8. A holder as recited in claim 1 wherein said surface of said holder is oriented to contact the flange of the plug at a location spaced from ends of the plug.

9. A holder as recited in claim 1 further comprising a base having a surface substantially parallel to the axis of the plug when the plug is installed in said holder.

10. A holder as recited in claim 9 further comprising a detent extending from said base and positioned to reduce rocking motion of the plug with respect to said holder after installation.

11. A holder as recited in claim 1 wherein a flange portion defines said recess, said flange portion facilitating a snap-in engagement of the plug to resist unintended release of the plug from said holder.

12. A holder as recited in claim 11, said flange portion including a pair of opposed flange members having facing surfaces defining said recess.

13. A holder as recited in claim 1 wherein a flange portion defines a cavity providing said surface and shaped to receive the flange of the plug.

14. A holder as recited in claim 13, said flange portion comprising at least two walls.

15. A holder as recited in claim 1, further comprising attachment means for attaching said holder to a fixture.

16. A method for testing an optoelectronic device comprising the steps of:
(a) providing a test plug connected to a fiber-optic cable of an optoelectronic device;
(b) providing a holder defining a recess configured to releasably engage a body of the test plug and a surface oriented for contact with a flange extending outwardly from the body of the test plug;
(c) releasably engaging the test plug in the holder;
(d) resisting movement of the test plug with respect to the holder in a direction transverse to the axis of the test plug using the recess defined by the holder; and
(e) resisting movement of the test plug with respect to the holder in a direction along the axis of the test plug using the surface defined by the holder.

17. A method as recited in claim 16 further comprising the steps of providing a test head positionable adjacent to an end of the test plug, and moving the test head to a position adjacent the test plug.

18. A method as recited in claim 17, wherein the test head is provided with an opening oriented to be substantially co-axial with the test plug and sized to receive the end of the test plug, said moving step comprising receiving the end of the test plug in the opening of the test head.

19. A method as recited in claim 16, wherein said releasably engaging step comprises installing the test plug downwardly into the holder.

20. A method as recited in claim 16, wherein said steps are repeated for each of a plurality of optoelectronic devices.
